(19) United States
(12) Patent Application Publication
(10) Pub. No.: US 2008/0222601 A1
(43) Pub. Date: Sep. 11, 2008

(54) Method and system for processing data contained within COBOL or PL/I record description entries and storage medium for storing instructions which effectuate the method

(76) Inventors: Kenneth L. Cauvin, Livonia, MI (US); Irene A. Ford, Plymouth, MI (US); Hiroshi Abe, West Bloomfield, MI (US); Patricia A. Niezgoda, Canton, MI (US); Charles E. Pickett, Livonia, MI (US); Thomas C. Zavela, Farmington Hills, MI (US)

Correspondence Address: BROOKS KUSHMAN P.C., 1000 TOWN CENTER, TWENTY-SECOND FLOOR, SOUTHFIELD, MI, 48075, US

(21) Appl. No.: 11/715,131

(22) Filed: Mar. 6, 2007

(51) Int. Cl. G06F 9/44

(52) U.S. Cl. 717/115

(57) ABSTRACT

A method and system for processing data contained within COBOL or PL/I record description entries and storage medium for storing instructions which effectuate the method are provided. The method includes receiving a first COBOL or PL/I software instruction which includes a first set of criteria for a first data field of data fields of the entries and having a generic subscript/occurrence for the first data field. The method further includes automatically processing all occurrences of the first data field within the record description entries based on the first set of criteria.

### BACKGROUND OF THE INVENTION

1. Field of the Invention

This invention relates to methods and systems for processing data contained within COBOL or PL/I record description entries and storage media for storing instructions which effectuate the methods.

2. Background Art

Particular types of data such as address or phone numbers, for example, may occur more than once in the same record on a file. Such data can be defined as an ARRAY or OCCURS. An ARRAY or OCCURS may have multiple dimensions. When accessing such data fields, the desired occurrence must be specified by a subscript for each dimension. A subscript may be a specific number or a variable, but when being processed, the variable must have been set to a specific value.

The following are sample COBOL and PL/I record layouts, respectively:

### COBOL Sample:

| | |
|---|---|
| 01 | RECORD-LAYOUT. |

| | |
|---|---|
| 05 | GROUP1 OCCURS 2 TIMES. |

| | |
|---|---|
| 10 | GROUP2 OCCURS 3 TIMES. |

| | |
|---|---|
| 15 | GROUP3 OCCURS 4 TIMES. |

| | |
|---|---|
| 20 | FIELD1 PIC X. |
| 20 | FIELD2 PIC X. |

### PL/I Sample:

| | |
|---|---|
| DCL 01 | RECORD_LAYOUT, |

| | |
|---|---|
| 05 | GROUP(2,3,4), |

| | |
|---|---|
| 10 | FIELD1 CHAR(1), |
| 10 | FIELD2 CHAR(1); |

The above samples define two fields (FIELD1 and FIELD2) which exist within a three dimensional ARRAY/OCCURS. The first dimension has two occurrences, the second dimension has three occurrences, and the third dimension has four occurrences. In total, FIELD1 and FIELD2 occur 24 times (2×3×4).

In the prior art, reference to a field within an ARRAY/OCCURS required the specification of one subscript for each dimension. For example, using the above samples, FIELD1 (1,2,3) or FIELD1 (X,Y,Z). When using a variable such as X, or Y, or Z, the variables must have been set to specific values prior to referencing the associated field as previously mentioned.

Prior art selection criteria solutions allowed for testing the data content of one or more fields but each occurrence of a field within an ARRAY/OCCURS had to be individually referenced. For example, using the above samples, if one wanted to select a record that contained an “A” in any of the 24 occurrences of FIELD1, one would have to code something like the following: If FIELD1(1,1,1)=“A”, or FIELD1(1,1,2)=“A”, or FIELD1(1,1,3)=“A”, or FIELD1(1,1,4)=“A”, or FIELD1(1,2,1)=“A”, or . . . FIELD1(2,3,4)=“A”. If one wanted to select a record that contained an “A” in all 24 occurrences of FIELD1, one would change the or's to and's in the previous example.

Prior art change criteria solutions allowed for changing the data content of one or more fields but each occurrence of a field within an ARRAY/OCCURS had to be individually referenced. For example, using the above samples, if one wanted to change the content of all 24 occurrences of FIELD2 to a “B”, one would have to code something like the following: FIELD2(1,1,1)=“B”; FIELD2(1,1,2)=“B”; . . . FIELD2(2,3,4)=“B”.

In the prior art, selection criteria and change criteria could be combined to make the changes conditional but when fields were defined within an ARRAY/OCCURS each occurrence had to be individually referenced. For example, using the above samples, if one wanted to change the content of FIELD2 to a “B” whenever FIELD1 in the same occurrence contained an “A”, one would have to code something like the following: If FIELD1(1,1,1) =“A” then FIELD2(1,1,1)=“B”; if FIELD1(1,1,2)=“A” then FIELD2(1,1,2)=“B”; . . . if FIELD1(2,3,4)=“A” then FIELD2(2,3,4)=“B”.

U.S. Pat. No. 6,427,145 discloses a method of selecting records from an ARRAY when any of the operational elements satisfies a given condition. The disclosure centers around SQL and transaction processing within an array. By transaction processing, a user builds a transaction statement (SQL) and sends it to the database processor. This may be in parallel with other users doing likewise in a centralized database system.

U.S. Pat. No. 6,985,895 discloses a method addressing scheme that uses relative addressing to replace values from one array with updated values. The disclosure concentrates its entire description around transaction processing using an SQL-like language within a spreadsheet database. The entire application centers around a spreadsheet.

The following websites are also related:
“ALL, ANY, and SOME Subqueries,”
<http://publib.boulder.ibm.com/infocenter.idshelp/v10/topic/com.ibm.sqls.doc/sqls981.htm>
“ISO/IEC 10744-7.7 Reference Control,”
<http://www.pms.ifi.lmu.de/mitarbeiter/ohlbach/multimedia/HYTIME/ISO/clause-7.7.html>
“PostgreSQL 8.1 Documentation,”
<http://www.commonadprompt.com/community/pgdocs81/arrays>
“Subscripting,”
<http://publib.boulder.ibm.com/infocenter/comphelp/v7v91/topic/com.ibm.aix.
cbl.doc/rlrefsub.htm>
“SEARCH Statement,”
<http://publib.boulder.ibm.com/infocenter/comphelp/v7v91/topic/com.ibm.aix. cbl.doc/rlpessear.htm>

### SUMMARY OF THE INVENTION

An object of the present invention is to provide a method and system for processing data contained within COBOL or PL/I record description entries and storage medium for storing instructions which effectuate the method. At least one embodiment of the present invention: requires fewer lines of code when specifying selection and/or change criteria; shortens selection and/or change criteria preparation time; and makes selection and/or change criteria more readable and easier to understand.

In carrying out the above object and other objects of the present invention, a method is provided for processing COBOL or PL/I language record description entries. The method includes providing COBOL or PL/I language record description entries having data fields. The method also includes receiving a first COBOL or PL/I software instruction which includes a first set of criteria for a first data field of the data fields and having a generic subscript/occurrence for the first data field. The method further includes automatically processing all occurrences of the first data field within the record description entries based on the first set of criteria.

The first set of criteria may include selection criteria and the step of processing that selection criteria may include the step of automatically selecting all occurrences of the first data field within the record description entries.

The generic subscript/occurrence may be “ANY”.

The generic subscript/occurrence may be “EVERY”.

The first set of criteria may include change criteria and the step of processing may include the step of automatically applying the change criteria to all occurrences of the first data field within the record description entries.

The first set of criteria may include selection criteria having a generic subscript/occurrence and change criteria having a generic subscript/occurrence and the step of processing may include the step of automatically and conditionally applying the change criteria to all occurrences of the first data field within the record description entries.

The generic subscript/occurrence of the selection criteria may be “ANY” and the generic subscript/occurrence of the change criteria may be “SAME”.

The method may include the step of receiving a second COBOL or PL/I software instruction which includes a second set of criteria for a second data field of the data fields and having a generic subscript/occurrence for the second data field. The method may further include automatically processing all occurrences of the second data field within the record description entries based on the second set of criteria.

Still further in carrying out the above object and other objects of the present invention, a system is provided for processing COBOL or PL/I language record description entries. The system includes means for providing COBOL or PL/I language record description entries having data fields. The system also includes means for receiving a first COBOL or PL/I software instruction which includes a first set of criteria for a first data field of the data fields and which has a generic subscript/occurrence for the first data field. The system further includes a processor for automatically processing all occurrences of the first data field within the record description entries based on the first set of criteria.

The first set of criteria may include selection criteria and the processor may automatically select all occurrences of the first data field within the record description entries.

The generic subscript/occurrence may be “ANY”.

The generic subscript/occurrence may be “EVERY”.

The first set of criteria may include change criteria and a processor may automatically apply the change criteria to all occurrences of the first data field within the record description entries.

The first set of criteria may include selection criteria having a generic subscript/occurrence and change criteria having a generic subscript/occurrence. The processor may automatically and conditionally apply the change criteria to all occurrences of the first data field within the record description entries.

The generic subscript/occurrence of the selection criteria may be “ANY” and the generic subscript/occurrence of the change criteria may be “SAME”.

The means for receiving may receive a second COBOL or PL/I software instruction which includes a second set of criteria for a second data field of the data fields and having a generic subscript/occurrence for the second data field. The processor may automatically process all occurrences of the second data field within the record description entries based on the second set of criteria.

Yet further in carrying out the above object and other objects of the present invention, a computer readable storage medium that stores a set of software instructions which, when executed, processes COBOL or PL/I language record description entries is provided. The set of software instructions includes instructions for providing COBOL or PL/I language record description entries having data fields. The set also includes instructions for receiving a first COBOL or PL/I software instruction which includes a first set of criteria for a first data field of the data fields and having a generic subscript/occurrence for the first data field. The set of instructions further includes instructions for automatically processing all occurrences of the first data field within the record description entries based on the first set of criteria.

The first set of criteria may include selection criteria and the instructions for processing may include instructions for automatically selecting all occurrences of the first data field within the record description entries.

The generic subscript/occurrence may be “ANY”.

The generic subscript/occurrence may be “EVERY”.

The first set of criteria may include change criteria and the instructions for processing may include instructions for automatically applying the change criteria to all occurrences of the first data field within the record description entries.

The first set of criteria may include selection criteria having a generic subscript/occurrence and change criteria having a generic subscript/occurrence. The instructions for processing may include instructions for automatically and conditionally applying the change criteria to all occurrences of the first data field within the record description entries.

The generic subscript/occurrence of the selection criteria may be “ANY” and the generic subscript/occurrence of the change criteria may be “SAME” in the storage medium.

The instructions for receiving may receive a second COBOL or PL/I software instruction which includes a second set of criteria for a second data field of the data fields and having a generic subscript/occurrence for the second data field. The instructions for processing may automatically process all occurrences of the second data field within the record description entries based on the second set of criteria.

The above object and other objects, features, and advantages of the present invention are readily apparent from the following detailed description of the best mode for carrying out the invention when taken in connection with the accompanying drawings.

### BRIEF DESCRIPTION OF THE DRAWINGS

FIG. 1a is a sample COBOL layout to be utilized as an example with the prior art disguise process flow of FIG. 1b;

FIG. 1b is a block diagram flowchart illustrating a disguise process flow of the prior art;

FIG. 2a is a sample COBOL layout, identical to the sample COBOL layout of FIG. 1a, to be utilized as an example with the disguise process flow of FIG. 2b;

FIG. 2b is a block diagram flowchart of a disguise process flow wherein blocks 110-122 are identical to the blocks 10-22 of FIG. 1b and wherein blocks 124-134 use EVERY as a subscript in accordance with one embodiment of the present invention;

FIG. 2c is a block diagram flowchart illustrating the steps taken by a disguise program method of one embodiment of the present invention;

FIG. 3a is a second sample COBOL language layout to be utilized as an example with the prior art disguise process flow of FIGS. 3b and 3c;

FIGS. 3b and 3c are block diagram flowcharts illustrating a second disguise process flow of the prior art;

FIG. 3d is a sample COBOL layout identical to the sample COBOL layout of FIG. 3a, to be utilized as an example with the disguise process flow of FIG. 3e;

FIG. 3e is a block diagram flowchart of a disguise process flow wherein blocks 326-348 use ANY and ANY, SAME as subscripts in accordance with an embodiment of the present invention and wherein blocks 310-318 are identical to blocks 210-218 of FIG. 3b; and

FIG. 3f is a block diagram flowchart illustrating the steps taken by a disguise program method of one embodiment of the present invention.

### DETAILED DESCRIPTION OF THE PREFERRED EMBODIMENT(S)

In general, the present invention provides a method and system for processing data contained within COBOL or PL/I record description entries and storage medium for storing instructions which effectuate the method.

At least one embodiment of the present invention: (1) allows for specifying “ANY”, “EVERY”, and/or “SAME” as the subscript/occurrence for a field that is defined within an ARRAY/OCCURS; (2) treats a subscript/occurrence of “ANY” within selection criteria as an “or” condition between different occurrences of the same field and will cause all occurrences of that field to be considered; for example using the above samples, if one wanted to select a record that contained an “A” in any of the 24 occurrences of FIELD1, one could code something like the following: If FIELD1(ANY)=“A”; (2) treats a subscript/occurrence of “EVERY” within selection criteria as an “and” condition between the different occurrences of the same field and will cause all occurrences of that field to be considered; for example using the above COBOL and PL/I samples, if one wanted to select a record that contained an “A” in all 24 occurrences of FIELD1, one could code something like the following: If FIELD1(EVERY)=“A”; (4) allows a subscript/occurrence of “EVERY” within change criteria which will cause all occurrences to be changed; for example using the above samples, if one wanted to change the content of all 24 occurrences of FIELD2 to a “B”, one could code something like the following: FIELD2(EVERY)=“B”; and (5) allows for making conditional changes of fields that are defined within an ARRAY/OCCURS by combining selection criteria with “ANY” specified as the subscript/occurrence with change criteria with “SAME” specified as the subscript/occurrence; for example using the above samples, if one wanted to change the content of FIELD2 to a “B” whenever FIELD1 in the same occurrence contained an “A”, one could code something like the following: If FIELD1(ANY)=“A” then FIELD2(SAME)=“B”.

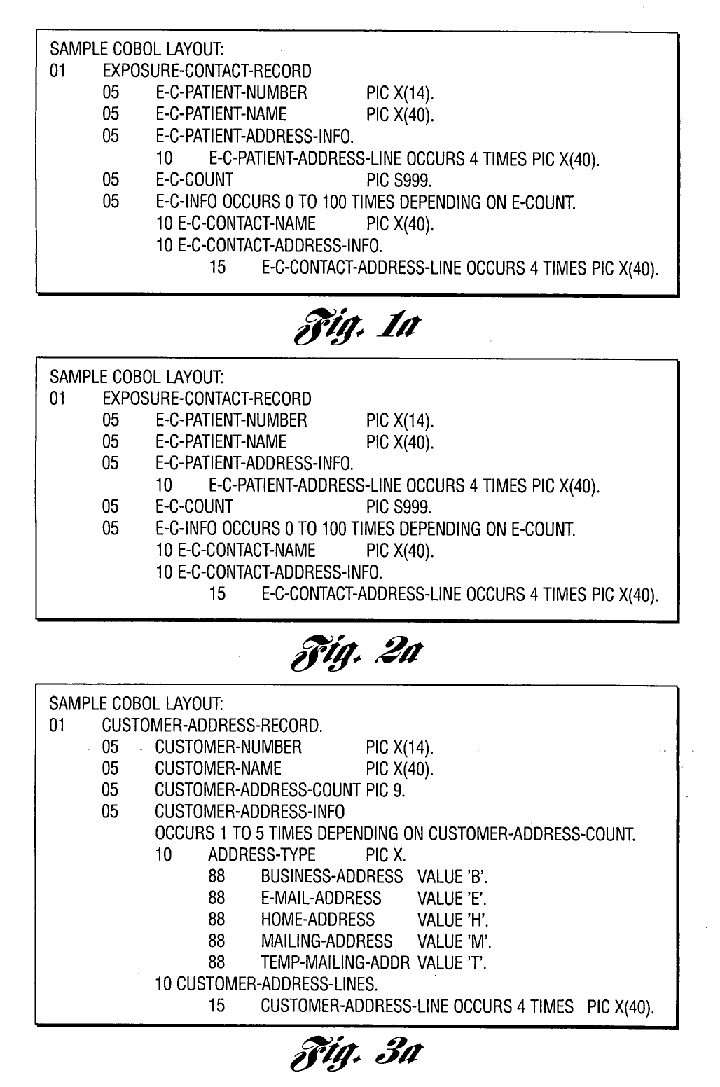

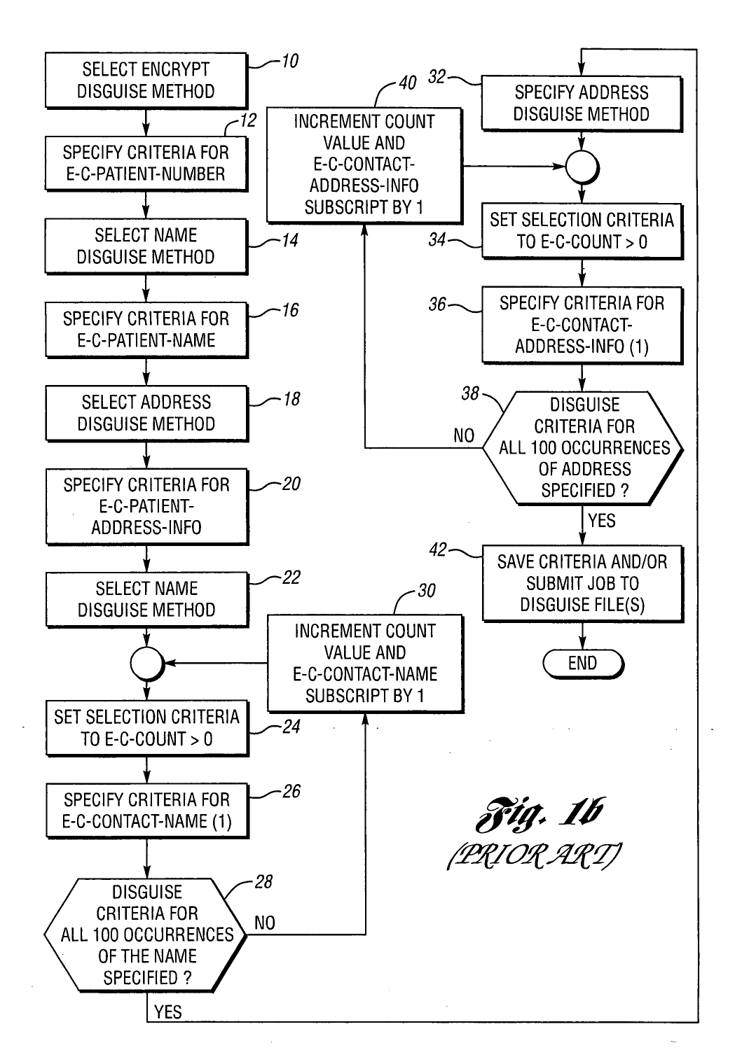

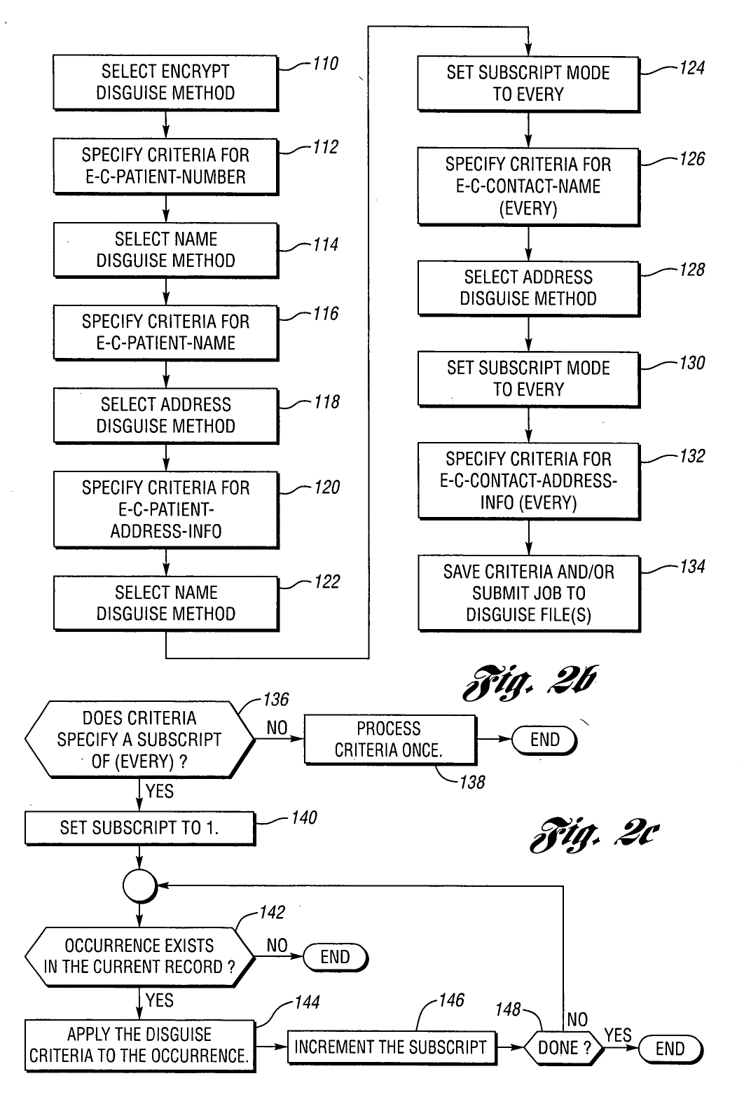

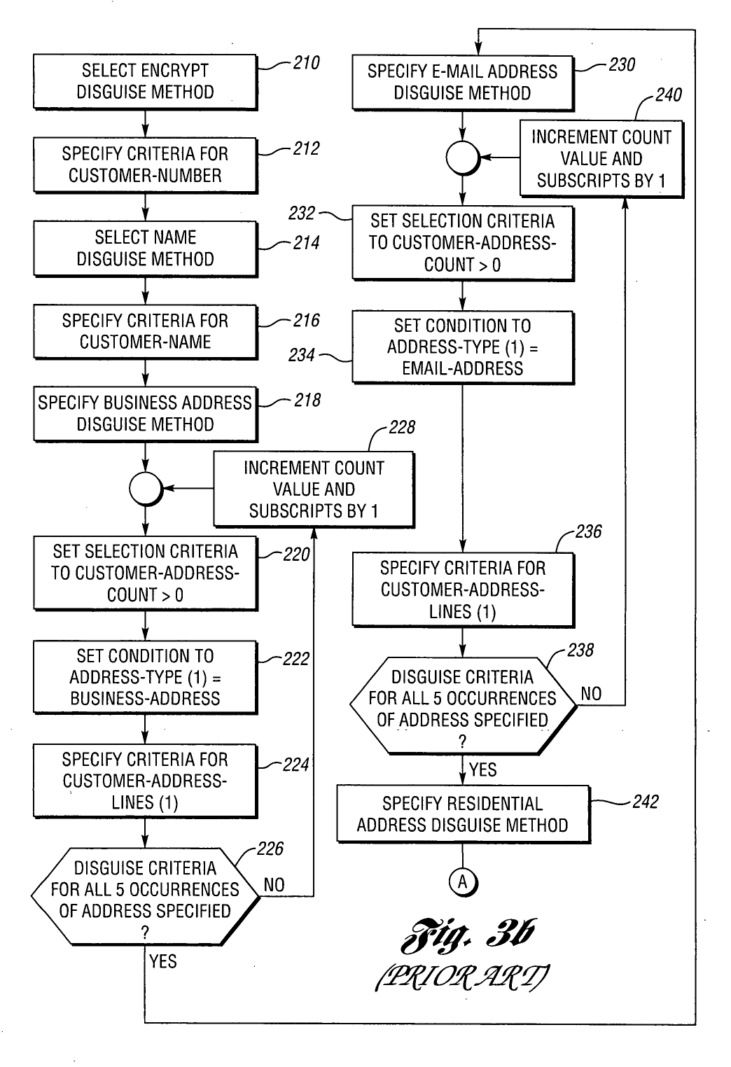

Referring now to the drawing figures, FIG. 1a is a sample COBOL layout which is utilized hereinbelow in describing the prior art disguise process flow of FIG. 1b and which is repeated in FIG. 2a. A comparison of FIG. 1b with FIGS. 2b and 2c help to illustrate the differences of one embodiment of the present invention with respect to the prior art method and system for processing fields of COBOL and PL/I record description entries.

Referring specifically now to FIG. 1b, at block 10, a particular type of ENCRYPT disguise method is selected. It is to be understood that other types of disguise or change methods may be selected typically through a graphical user interface as is well known in the art. Also, through the graphical user interface, a file may be specified as well as layout information.

At block 12, criteria for the E-C-PATIENT-NUMBER field of FIG. 1a is specified by a user also through the graphical user interface.

At block 14, a name disguise method is selected for the E-C PATIENT NAME field illustrated in FIG. 1a. This selection typically also occurs through the graphical user interface.

At block 16, criteria for the E-C-PATIENT-NAME field is specified by a user also through the graphical user interface.

At block 18, an address disguise method is selected for the address field of FIG. 1a through the graphical user interface.

At block 20, criteria for the field E-C-PATIENT-ADDRESS-INFO is specified by a user through the graphical user interface.

At block 22, a name disguise method is selected by a user through the graphical user interface.

At block 24, a selection criteria to E-C-COUNT>0 is set through the graphical user interface.

At block 26, criteria for the field E-C-CONTACT-NAME (1) is specified through the graphical user interface.

At block 28, a test is performed to determine if the disguise criteria for all 100 occurrences of the name is specified. If “no,” at block 30, the count value and the subscript for the field E-C-CONTACT-NAME are incremented by 1 and block 24 is reentered.

If the test at block 28 (wherein it is determined whether the disguise criteria for all 100 occurrences of the name field are specified) provides an answer of “yes,” then block 32 is entered wherein an address disguise method is specified.

At block 34, selection criteria to the field E-C-COUNT>0 is entered. At block 36, criteria for the field E-C-CONTACT-ADDRESS-INFO (1) is specified.

At block 38, it is determined whether the disguise criteria for all 100 occurrences of the address is specified. If “no,” at block 40, the count value and the subscript for the field E-C-CONTACT-ADDRESS-INFO (1) are both incremented by 1 and block 34 is reentered.

If it is determined at block 38 that the disguise criteria for all 100 occurrences of the address specified is “yes,” then block 42 is entered wherein the criteria are saved and the job is submitted to disguise the file(s).

The disguise program of the prior art (not shown) processes all criteria once and the client or user has to repeat the disguise steps him or herself.

Referring now to FIGS. 2a and 2b (wherein FIG. 2a is identical to FIG. 1a), one embodiment of the method and system of the invention is disclosed for processing the sample COBOL layout of FIG. 2a as illustrated in the block diagram flowchart of FIG. 2b wherein blocks 110-122 are identical to blocks 10-22 of FIG. 1b as described above.

Referring specifically to FIG. 2b, at block 124, subscript mode is set to EVERY through a graphical user interface.

At block 126, criteria for the field E-C-CONTACT-NAME (EVERY) is specified also through the graphical user interface.

At block 128, a particular address disguise method is selected through the graphical user interface.

At block 130, subscript mode is set to EVERY through the graphical user interface.

At block 132, criteria for the field E-C-CONTACT-ADDRESS-INFO (EVERY) is specified through the graphical user interface.

At block 134, the criteria is saved and/or the job is submitted to disguise the file(s).

Referring now to FIG. 2c, there is illustrated, in block diagram flowchart form, the disguise program process or method in accordance with one embodiment of the present invention.

At block 136, it is determined whether the criteria determined in FIG. 2b specifies a subscript of (EVERY). If no, at block 138, the criteria is processed once and the program ends.

If at block 136 the criteria does specify a subscript of (EVERY), then the subscript is automatically set to 1 at block 140.

At block 142, it is determined whether an occurrence exists in the current record. If “no,” the program ends. If “yes,” the disguise criteria is applied to the occurrence at block 144 and at block 146 the subscript is incremented.

At block 148, it is determined whether the program is done. If not, block 142 is reentered and if “yes,” the program ends.

As described above and by comparing FIG. 1b with FIGS. 2b and 2c, the advantages accruing to the use of at least one embodiment of the invention are obvious.

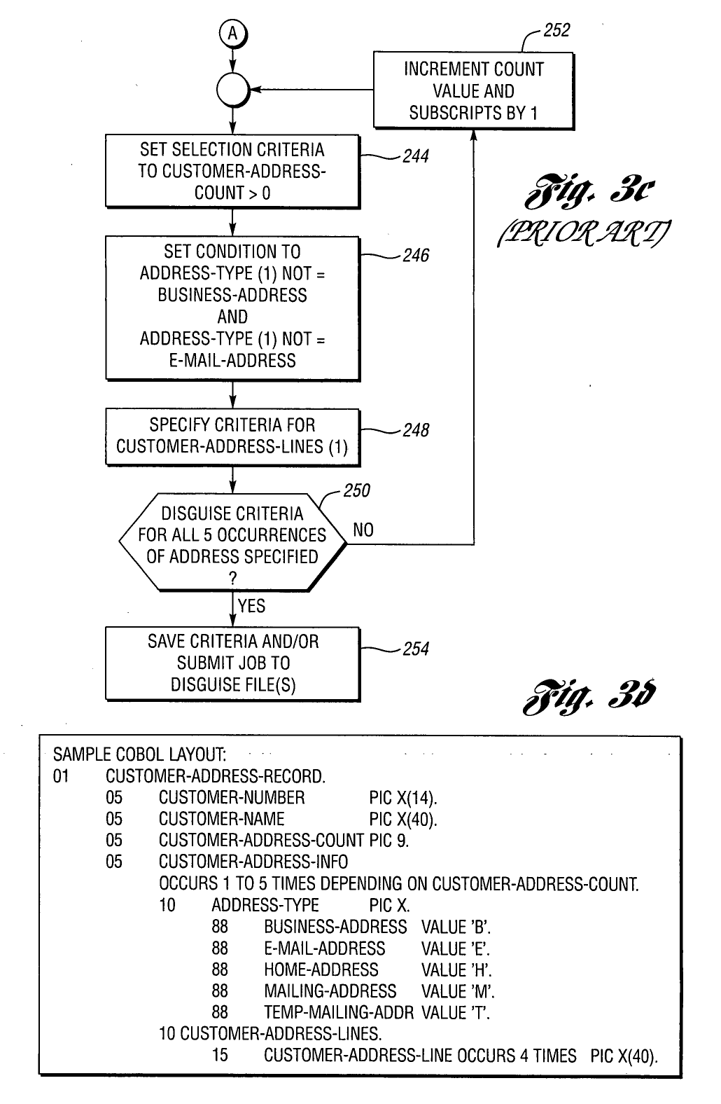

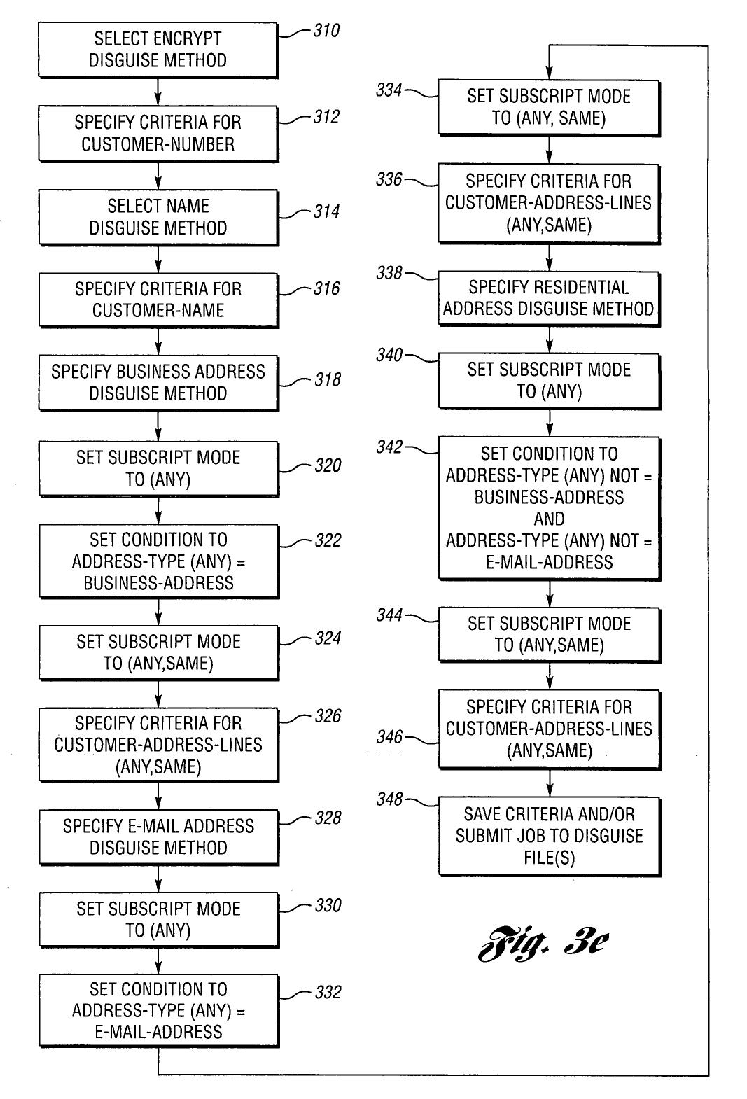

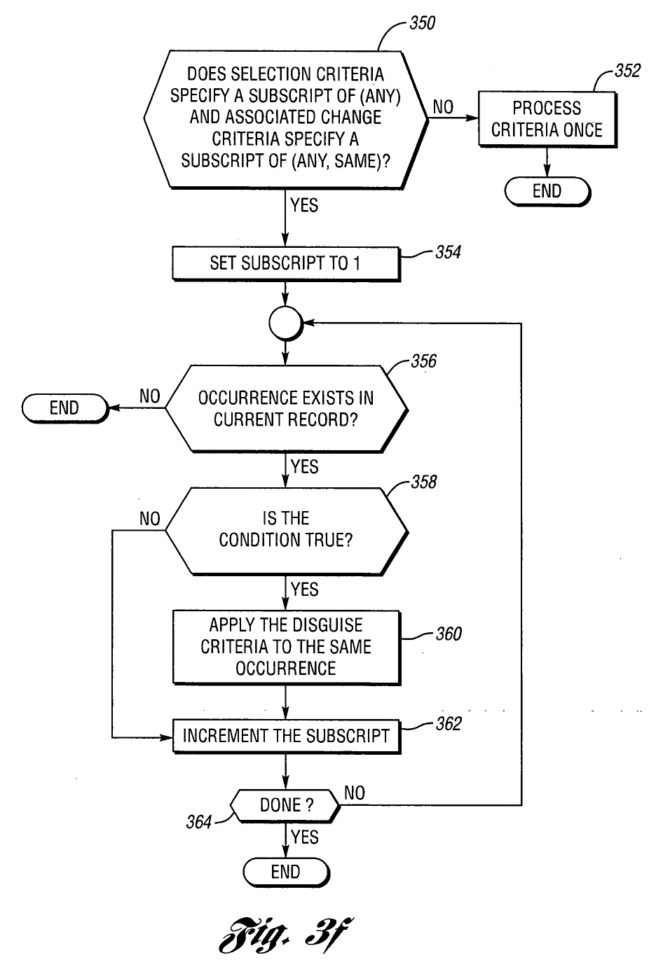

Referring now to FIGS. 3b and 3c, there is illustrated a prior art method of processing fields within COBOL and PL/I record description entries using specific subscripts with reference to a sample COBOL layout of FIG. 3a. FIGS. 3b and 3c illustrate a disguise process flow using specific subscripts.

At block 210, an ENCRYPT disguise method is selected through a graphical user interface.

At block 212, criteria for the field CUSTOMER-NUMBER of FIG. 3a is specified.

At block 214, a name disguise method is selected through the graphical user interface.

At block 216, criteria for the field CUSTOMER-NAME of FIG. 3a is specified.

At block 218, a business address disguise method is specified according to the layout of FIG. 3a.

At block 220, selection criteria to the field CUSTOMER-ADDRESS-COUNT>0 is set.

At block 222, condition to ADDRESS-TYPE (1)=BUSINESS-ADDRESS is set.

At block 224, criteria for the field CUSTOMER-ADDRESS-LINES (1) is specified.

At block 226, it is determined whether disguise criteria for all 5 occurrences of the address are specified. If “no,” block 228 is entered wherein the count value and subscripts are incremented by 1. Then block 220 is reentered.

If it is determined at block 226 that the disguise criteria for all 5 occurrences of address are specified, then block 230 is entered wherein an e-mail address disguise method is specified by a user through the GUI.

At block 232, the selection criteria to the field CUSTOMER-ADDRESS-COUNT>0 is set.

At block 234, condition to ADDRESS-TYPE (1)=E-MAIL-ADDRESS is set.

At block 236, criteria for the field CUSTOMER-ADDRESS-LINES (1) is specified.

At block 238, it is determined whether the disguise criteria for all 5 occurrences of the address are specified. If not, block 240 is entered wherein the count value and subscripts are incremented by 1 and block 232 is reentered. If at block 238 it is determined that the disguise criteria for all 5 occurrences of the address are specified, then block 242 in FIG. 3c is entered wherein a residential address disguise method is specified by a user through the GUI.

At block 244 of FIG. 3c, the selection criteria to the field CUSTOMER-ADDRESS-COUNT>0 is set.

At block 246, condition to ADDRESS-TYPE (1) NOT=BUSINESS-ADDRESS AND ADDRESS-TYPE (1) NOT=E-MAIL-ADDRESS is set.

At block 248, criteria for the field CUSTOMER-ADDRESS-LINES (1) is specified through the GUI.

At block 250, it is determined whether the disguise criteria for all 5 occurrences of the address are specified. If not, at block 252 the count value and subscripts are incremented by 1 and block 244 is reentered.

If it is determined at block 250 that the disguise criteria for all 5 occurrences of the address are specified, then at block 254 the criteria is saved and/or the job is submitted to disguise the file(s).

Referring now to FIGS. 3e and 3f, there is illustrated a method and system of processing COBOL and/or PL/I record description entries in accordance with an embodiment of the present invention with reference to the sample COBOL language layout of FIG. 3d which is identical to the sample COBOL layout of 3a. Blocks 310-318 of FIG. 3e are identical to blocks 210-218 of FIG. 3b and their description will not be repeated.

At block 320 of FIG. 3e, subscript mode to (ANY) is set.

At block 322, condition is set to ADDRESS-TYPE (ANY)=BUSINESS-ADDRESS.

At block 324, subscript mode is set to (ANY, SAME).

At block 326, criteria for CUSTOMER-ADDRESS-LINES (ANY, SAME) are specified.

At block 328, an e-mail address disguise method is specified by a user through the GUI.

At block 330, subscript mode to (ANY) is set.

At block 332, a condition is set to ADDRESS-TYPE (ANY)=E-MAIL-ADDRESS.

At block 334, subscript mode is set to (ANY,SAME).

At block 336, criteria is specified for CUSTOMER-ADDRESS-LINES (ANY,SAME).

At block 338, a residential address disguise method is specified by a user through the GUI.

At block 340, subscript mode is set to (ANY).

At block 342, condition is set to ADDRESS-TYPE (ANY) NOT=BUSINESS-ADDRESS AND ADDRESS-TYPE (ANY) NOT=E-MAIL-ADDRESS.

At block 344, the subscript mode is set to (ANY,SAME).

At block 346, criteria is specified for CUSTOMER-ADDRESS-LINES (ANY, SAME).

At block 348, the criteria is saved and/or the job is submitted to disguise file(s).

Referring now to FIG. 3f, a disguise program process or method of one embodiment of the present invention is entered at block 350 wherein it is determined whether the selection criteria specifies a subscript (ANY) and the associated change criteria specifies (ANY,SAME). If not, the criteria is processed once at block 352 and the program ends. If at block 350 the selection criteria specifies a subscript of (ANY) and the associated change criteria specifies (ANY,SAME), then the subscript is automatically set to 1 at block 354.

At block 356, it is determined whether an occurrence exists in the current record.

If not, the program ends. If “yes,” at block 358 it is determined if the condition is true. If not, then block 362 is entered to increment the subscript. If “yes,” at block 360 the disguise criteria is applied to the same occurrence.

At block 362, the subscript is incremented.

If the program is not done at block 364, then block 356 is reentered. If the program is done at block 364, then the program ends.

As illustrated above, the disguise program of FIG. 3f repeats the disguise steps rather than having a user repeat the disguise steps.

The advantages accruing through the use of the above-described method, system and computer readable storage medium that stores a set of instructions which, when executed, effectuate the method of the present invention are numerous. For example, with respect to at least one embodiment of the present invention, fewer lines need to be coded when specifying selection and/or change criteria. Also, selection and/or change criteria preparation time is shortened.

Furthermore, the making of selection and/or change criteria more readable and easier to understand is possible.

For example, one can use change criteria subscript (ANY,ALL) when change criteria mode is ANY but the subscripted field does not have corresponding selection criteria with a subscript (ANY). (ANY,ALL) is a synonym for (EVERY) but is used to alert the user that the criteria is in (ANY) mode.

Other possible synonyms for the above-noted subscripts are SOME, or EACH.

In one embodiment of the invention, selection criteria can be specified on multiple fields within the same criteria set and can be any combination of non-subscripted fields, fields with specific subscripts, fields with a subscript of (ANY), and/or fields with a subscript of (EVERY).

In one embodiment of the invention, change criteria can be specified on multiple fields within the same criteria set and can be any combination of subscripted and non-subscripted fields. The change criteria subscripts are limited to 1 type which can be specific, (ANY,?), or (EVERY). (ANY,?) is either (ANY,SAME) if there is corresponding selection criteria with a subscript of (ANY) or (ANY,ALL) if there is no corresponding selection criteria with a subscript of (ANY).

For example, one can have a COBOL record description which has 2 separate non-nested OCCURS statements. One can specify selection criteria on the first OCCURS group with a subscript of (ANY). Change criteria on fields within the first group would have a subscript of (ANY,SAME) and the occurrences would be controlled by the selection criteria. Change criteria on fields in the second group would be applied only if the selection criteria were true on at least 1 occurrence in group 1 but all (ANY,ALL) the occurrences for fields in group 2 would be changed.

A set of criteria may contain just selection criteria, just change criteria, or both selection and change criteria.

Change criteria without selection criteria is applied to all records in the file being processed.

Selection criteria without change criteria would not change any records but would only process the selected records.

When both selection criteria and change criteria are specified, the selection criteria is processed first to determine which records should be processed and then the change criteria is applied to all selected records. During the change criteria process whenever the change criteria subscript specifies (ANY,SAME), the corresponding (ANY) selection criteria is re-evaluated to determine which occurrences should be changed. Change criteria that does not specify a subscript of (ANY,SAME), which means there is no corresponding selection criteria with a subscript of (ANY), is applied to all occurrences.

There can also be various combinations of both subscripted and/or non-subscripted fields specified in the same criteria as one of ordinary skill in the art can readily appreciate and, consequently, the process flow for handling such combinations is not explained in detail herein.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method for processing COBOL or PL/I language record description entries, the method comprising:
providing COBOL or PL/I language record description entries having data fields;
receiving a first COBOL or PL/I software instruction which includes a first set of criteria for a first data field of the data fields and having a generic subscript/occurrence for the first data field; and
automatically processing all occurrences of the first data field within the record description entries based on the first set of criteria.

2. The method as claimed in claim 1, wherein the first set of criteria include selection criteria and wherein the step of processing includes the step of automatically selecting all occurrences of the first data field within the record description entries.

3. The method as claimed in claim 2, wherein the generic subscript/occurrence is “ANY”.

4. The method as claimed in claim 2, wherein the generic subscript/occurrence is “EVERY”.

5. The method as claimed in claim 1, wherein the first set of criteria includes change criteria and wherein the step of processing includes the step of automatically applying the change criteria to all occurrences of the first data field within the record description entries.

6. The method as claimed in claim 5, wherein the generic subscript/occurrence is “EVERY”.

7. The method as claimed in claim 1, wherein the first set of criteria includes selection criteria having a generic subscript/occurrence and change criteria having a generic subscript/occurrence and wherein the step of processing includes the step of automatically and conditionally applying the change criteria to all occurrences of the first data field within the record description entries.

8. The method as claimed in claim 7, wherein the generic subscript/occurrence of the selection criteria is “ANY” and the generic subscript/occurrence of the change criteria is “SAME”.

9. The method as claimed in claim 1 further comprising:
receiving a second COBOL or PL/I software instruction which includes a second set of criteria for a second data field of the data fields and having a generic subscript/occurrence for the second data field; and
automatically processing all occurrences of the second data field within the record description entries based on the second set of criteria.

10. A system for processing COBOL or PL/I language record description entries, the system comprising:
means for providing COBOL or PL/I language record description entries having data fields;
means for receiving a first COBOL or PL/I software instruction which includes a first set of criteria for a first data field of the data fields and having a generic subscript/occurrence for the first data field; and
a processor for automatically processing all occurrences of the first data field within the record description entries based on the first set of criteria.

11. The system as claimed in claim 10, wherein the first set of criteria include selection criteria and wherein the processor automatically selects all occurrences of the first data field within the record description entries.

12. The system as claimed in claim 11, wherein the generic subscript/occurrence is “ANY”.

13. The system as claimed in claim 11, wherein the generic subscript/occurrence is “EVERY”.

14. The system as claimed in claim 10, wherein the first set of criteria includes change criteria and wherein the processor automatically applies the change criteria to all occurrences of the first data field within the record description entries.

15. The system as claimed in claim 14, wherein the generic subscript/occurrence is “EVERY”.

16. The system as claimed in claim 10, wherein the first set of criteria includes selection criteria having a generic subscript/occurrence and change criteria having a generic subscript/occurrence and wherein the processor automatically and conditionally applies the change criteria to all occurrences of the first data field within the record description entries.

17. The system as claimed in claim 16, wherein the generic subscript/occurrence of the selection criteria is “ANY” and the generic subscript/occurrence of the change criteria is “SAME”.

18. The system as claimed in claim 10, wherein the means for receiving receives a second COBOL or PL/I software instruction which includes a second set of criteria for a second data field of the data fields and having a generic subscript/occurrence for the second data field and wherein the processor automatically processes all occurrences of the second data field within the record description entries based on the second set of criteria.

19. A computer readable storage medium that stores a set of software instructions which, when executed, processes COBOL or PL/I language record description entries, the set comprising instructions for:
providing COBOL or PL/I language record description entries having data fields;
receiving a first COBOL or PL/I software instruction which includes a first set of criteria for a first data field of the data fields and having a generic subscript/occurrence for the first data field; and
automatically processing all occurrences of the first data field within the record description entries based on the first set of criteria.

20. The storage medium as claimed in claim 19, wherein the first set of criteria include selection criteria and wherein the instructions for processing include instructions for automatically selecting all occurrences of the first data field within the record description entries.

21. The storage medium as claimed in claim 20, wherein the generic subscript/occurrence is “ANY”.

22. The storage medium as claimed in claim 21, wherein the generic subscript/occurrence is “EVERY”.

23. The storage medium as claimed in claim 19, wherein the first set of criteria include change criteria and wherein the instructions for processing includes instructions for automatically applying the change criteria to all occurrences of the first data field within the record description entries.

24. The storage medium as claimed in claim 23, wherein the generic subscript/occurrence is “EVERY”.

25. The storage medium as claimed in claim 19, wherein the first set of criteria includes selection criteria having a generic subscript/occurrence and change criteria having a generic subscript/occurrence and wherein the instructions for processing include instructions for automatically and conditionally applying the change criteria to all occurrences of the first data field within the record description entries.

26. The storage medium as claimed in claim 25, wherein the generic subscript/occurrence of the selection criteria is “ANY” and the generic subscript/occurrence of the change criteria is “SAME”.

27. The storage medium as claimed in claim 19, wherein the instructions for receiving receive a second COBOL or PL/I software instruction which includes a second set of criteria for a second data field of the data fields and having a generic subscript/occurrence for the second data field and wherein the instructions for processing automatically processes all occurrences of the second data field within the record description entries based on the second set of criteria.
